(19) United States
(12) Patent Application Publication
(10) Pub. No.: US 2015/0300298 A1
(43) Pub. Date: Oct. 22, 2015

(54) OVERMOLDED MOTORIZED VALVE WITH IMPROVED SEALING

(71) Applicants: Cédric MELLERE, Sonlce Cernay (FR); Pierre GANDEL, (US); SONCEBOZ AUTOMOTIVE SA, Sonceboz (CH)

(72) Inventors: Cédric MELLERE, Soulce Cernay (FR); Pierre GANDEL, Montfaucon (FR)

(73) Assignee: SONCEBOZ AUTOMOTIVE SA, Sonceboz (CH)

(21) Appl. No.: 14/440,732

(22) PCT Filed: Oct. 21, 2013
(86) PCT No.: PCT/FR2013/052505

§ 371 Date: May 5, 2015

(30) Foreign Application Priority Data
Nov. 6, 2012 (FR) 12/02971

(51) Int. Cl. F02M 25/07; F16K 31/04; F16K 27/02

(52) U.S. Cl. CPC F02M 25/0773; F16K 27/0218; F16K 31/042; F02M 25/0793

(57) ABSTRACT

A motorized valve is made up of a closable pipe, of a valve shutter, of a rotary electromagnetic actuator and of an overmoulding plastic material, the actuator being formed of a stator assembly, of a rotor secured to a spindle, the valve shutter being positioned progressively by the actuator using the spindle and able to shut off the pipe, the overmoulding plastic material surrounding and being secured at least in part to the actuator and forming the pipe at least in part, the static sealing being afforded by overmoulding plastic material common to the actuator and the pipe, and the overmoulding material having passing through it a passage that is rendered fluid-tight for guiding the spindle that connects the valve shutter and the rotor.

### CROSS-REFERENCE TO RELATED APPLICATIONS

This application is a National Phase Entry of International Application No. PCT/FR2013/052505, filed on Oct. 21, 2013, which claims priority to French Patent Application Serial No. 12/02971, filed on Nov. 6, 2012, both of which are incorporated by reference herein.

### TECHNICAL FIELD

The present invention relates to the field of instrumented valves and more particularly motorized valves intended to enable the regulation of the flow of fluids through a closable valve controlled by an actuator of the electromagnetic type.

### BACKGROUND

Heat engines, more particularly for motor vehicles, must comply with environmental standards as regards the discharge of polluting emissions and fuel consumption. Motor/engine manufacturers have developed and still develop various strategies aiming at meeting such obligations. The commonly used solution consists in recovering a part of the exhaust gases directly at the cylinder block outlet, for feeding them back upstream of the combustion chamber by mixing same with fresh air. This function is provided via an EGR (Exhaust Gas Recirculation) valve, driven by an electromagnetic actuator which more or less opens the valve to define the fraction of burnt gas to be returned to the intake.

Such a valve, as well as the actuator which controls same, is exposed to a great stress. As the assembly is built right in the engine block or on elements integral with the engine block (this is referred to as high-pressure EGR), the vibration level is high and gas temperature is extremely high. Therefore, the valve is usually made of metal (steel for the part in direct contact with gas, aluminum for the outer portion) and it may be cooled by a water circuit to prevent the system from overheating and be damaged.

As the environmental standards are always stricter, a new solution appeared, in addition to HP EGR. It is called LP (low pressure) EGR and uses the same principle as HP EGR, but with a different design. As the exhaust gases are captured downstream of the particle filter, the valve is not necessarily fixed to the engine block, but may be attached to the conduit system connecting the exhaust to the intake. The actuator+valve assembly is then exposed to a lower mechanical stress, more particularly a lower heat, since the gas temperature has significantly decreased. This more favourable environment enables other technical solutions and other materials than steel or aluminum to be implemented to produce the valve enabling to use technical plastics which become very good alternative solutions.

The currently used solution for a LP EGR valve is a “simple assembly” of an engine coupled on a valve produced by a motor vehicle equipment manufacturer. The valve is no longer made of steel, it is entirely made of aluminum and it is no longer cooled.

The design of the valve+actuator assembly is compact. The valve shutter is guided by a spigot link on the actuator side, it is free at its other end. This solution provides a good control of leakage rates (closed position) and is compact.

This valve is “failsafe”: an elastic return member, built-in between the movable part of the actuator (spindle) and the valve body is used for returning the valve to the closed position when the actuator is no longer power-supplied or in case of failure. It also makes it possible to press the valve shutter onto its seat and to ensure a minimum sealing level of the not power-supplied valve in the actuator. The elastic return means is a torsion spring which has the disadvantages of introducing friction, of being cumbersome and being difficult to assemble.

Eventually, sealing between the pipe of the valve and the actuator must be controlled. In order to prevent the exhaust gas from flowing along the spindle of the actuator and from possibly damaging same, a one-lip dynamic seal is integrated therein. It is sandwiched between the valve body and the inserted guide bearing. An O-ring is also used between the stator of the actuator and the valve to prevent external agents from penetrating into, and corroding, the assembly.

The patent application U.S. Patent Publication No. 2008/0295800 is known in the prior art, which describes a composite throttle body made of a high-performance composite material that is overmoulded with nylon to form the outer shell of the throttle body. This embodiment implements several distinct elements, including an actuator mounted on the body of the overmoulded valve. The actuator is associated with the body, which results in sealing problems.

The German Patent DE102007013937 describes a valve having an injection-moulded plastic part, which accommodates bearing devices, such as needle bearings. The bearing devices are supported independently of each other in the injection-moulded plastic part, and comprise an outer ring with individually formed support flanges. The devices are so arranged as to support a throttle flap shaft. This document provides a dual dynamic sealing solution on the spindle bearing the valve shutter. The shaft is not integral with the motor spindle, with the driving being provided by a reducer.

In summary, the solution of the state of the art meets the current needs, but several of its elements could be improved:

Depending on the operating temperatures, aluminum is not compulsory for the whole valve body.

The return-in-position function in case of failure (“failsafe”) is cumbersome, with a contact, and the production thereof entails management constraints.

The sealing function is binding since it requires a double sealing.

The assembling of an actuator with a valve has to be controlled, as the dimensions thereof have not been optimized.

Solutions are also known, as disclosed in patent EP1030041 (Dana) which describes a solution making it possible to reduce the weight and the cost of the actuator and facilitates the installation of the actuator into the valve. However, this solution requires the positioning of the actuator into the extended valve body and thus requires careful mounting which must take into account the tightness of the valve with the actuator by using multiple seals providing static sealing (i.e. the sealing between the two sets of different nature, which do not move relative to each other) and dynamic sealing (i.e. the sealing between two assemblies of a different kind which are stationary with respect to each other). Moreover, this solution does not ensure a good heat dissipation in the actuator because the actuator is not entirely fixed to and surrounded by the sleeve wherein it is installed.

The patent FR2896025 brings some improvements and in particular makes it possible, through the utilization of a global overmoulding of the actuator and the valve, to provide a coupling optimizing the heat dissipation in the actuator while improving the assembly and reducing the overhang in the actuator. However, this patent does not solve the sealing problem which arises because it uses a bearing but does not prevent the fluid from going up along the spindle of the actuator, which may pollute the latter and limit the service life thereof. As a matter of fact, this document of the prior art is intended to enable the shutting off of the low temperature and clean air pipe and the passage in the actuator is thus not a problem.

### SUMMARY

The present invention aims at remedying the sealing problems encountered in the solutions of the prior art by providing the valve with a complete sealing using only one seal, in addition to the advantages regarding compactness, strength and lightness brought by the use of overmoulding surrounding the actuator and the pipe. In order to remedy the above drawbacks and provide sealing, the solution of the present invention consists in using the plastic overmoulding (typically made of a liquid crystal polymer material—LCP) to provide static sealing. Only one dynamic seal is then required, unlike the solutions of the prior art.

One of the objects of the invention also consists in keeping only what is necessary and in overmoulding the valve (pipe) and actuator assembly at once, with a single tool. The magnetic part of the actuator (iron circuit, winding, connections . . . ) and the essential aluminum parts of the valve body (shut off seat for the sealing, support of the actuator) are then kept, and the rest will be made of plastic during the overmoulding operation. A compact one-piece valve+actuator assembly, which is lighter than the current one, is thus obtained.

One of the objects of the invention consists in providing the replacement of the member for the elastic return of the valve shutter by using a contactless magnetic return member such as described in patent FR2744559, which confers the advantages of a better compactness and a longer service life.

More particularly, the invention provides a motorized valve consisting of a closable pipe, of a valve shutter, of a rotary electromagnetic actuator and of an overmoulding plastic material, with said actuator being formed of a stator assembly, a rotor secured to a spindle, with the valve shutter being progressively positioned by said actuator using the spindle and able to shut off the pipe, with the overmoulding plastic material surrounding and being secured at least in part to the actuator and forming the pipe at least in part, characterized in that static sealing is provided by overmoulding plastic material common to the actuator and the pipe, with said overmoulding material being gone through by a passage for guiding the spindle which connects the valve shutter and the rotor. Said passage going through the overmoulding material preferably cooperates with said spindle by means of a sealing means.

In a non-restrictive alternative solution, the overmoulded passage is sealed by a lip seal carried by the spindle, below the overmoulded portion. Dynamic sealing is preferably provided through the utilization of a single seal in contact with the spindle. The motorized valve preferably comprises means for returning the valve shutter in position provided by a magnetic coupling making it possible to give the qualities of a contactless system (no wear) and a volume much lower than what can be provided with mechanical systems (spring). In a particular embodiment, the overmoulding plastic material forms the whole pipe, particularly if the working temperatures make it possible.

In a particular embodiment, the pipe comprises at least partly a base made of metal and a part made of an overmoulding plastic material. In this case, the stator assembly may be attached to the metal base of the pipe by threaded elements facilitating the angular indexing of the stator assembly with respect to the spindle of the pipe. The spindle of the actuator can then be positioned relative to the metal base of the pipe using a centering spigot attached to the pipe.

In another embodiment, the stator assembly is fixed to the metal base of the pipe by a centering spigot attached thereto. In a particular embodiment, the centering spigot attached to the pipe and a portion of the metal base of the pipe define a housing wherein the single seal is placed. In another embodiment, the spindle of the actuator is positioned with respect to the metal pipe using a centering spigot secured to the metal base of the pipe, i.e. the metal base is extended by a centering spigot. In this embodiment, the stator assembly is attached to the metal base of the pipe through the centering spigot secured to the metal base of the pipe.

In a particular embodiment, the single seal is placed on the spindle of the actuator in external static contact with the overmoulding plastic material and in internal sliding contact with the spindle of the actuator. In another embodiment, the single seal is positioned on the spindle of the actuator using a groove provided on the spindle.

In a particular embodiment, the motorized valve comprises a cover supporting a rotor position detecting element attached to the overmoulding plastic material and fixed by laser welding. In another embodiment, the cover has an electric connection assembly for supplying the actuator and the detecting element. In a particular embodiment, the spindle is guided at the stator assembly only.

### BRIEF DESCRIPTION OF THE DRAWINGS

Other characteristics and advantages of the invention will appear upon reading the following detailed exemplary embodiments, with reference to the appended figures which represent, respectively:

FIG. 1 is a three-quarter view of a motorized valve according to an embodiment of the prior art;

FIG. 2 is a three-quarter view of a motorized valve according to the invention;

FIG. 3 is an isolated view of the rotor of an actuator which can be used in the present invention;

FIG. 4 is an isolated view of an actuator which can be used in the present invention;

FIGS. 5a and 5b are sectional views respectively prior to and after the overmoulding, of a motorized valve according to a first embodiment;

FIGS. 6a and 6b are sectional views, respectively prior to and after the overmoulding, of a motorized valve according to a second embodiment;

FIGS. 7a and 7b are sectional views respectively prior to and after the overmoulding, of a motorized valve according to a third embodiment;

FIGS. 8a and 8b, cutting views respectively prior to and after the overmoulding, of a motorized valve according to a fourth embodiment; and

FIGS. 9a and 9b are sectional views, respectively prior to and after the overmoulding, of a motorized valve according to a fifth embodiment.

### DETAILED DESCRIPTION

FIG. 1 shows a motorized valve according to one embodiment of the prior art. In this conventional embodiment, this module is the simple association of a pipe 2, whereon an actuator 1 is fixed. This assembly, if it is viable and widely used has significant drawbacks as regards the volume, due to the attachment points 3 required for the actuator 1, and has an important weight due to the fact that the pipe 2 is made of aluminum, and different thermal behaviours between the pipe 2 and the actuator 1.

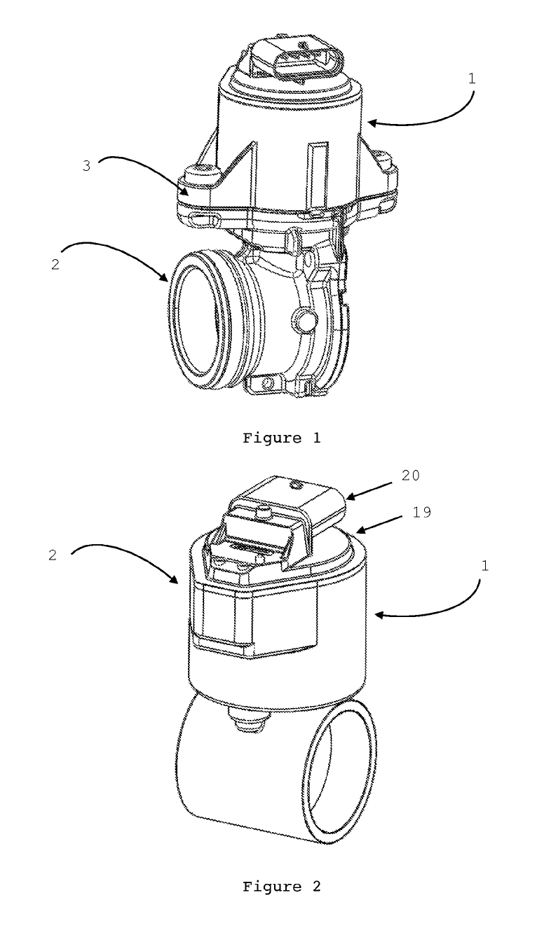

FIG. 2 shows a motorized valve according to the invention wherein the pipe 2, at least partially overmoulded, and the actuator 1, also overmoulded, are provided. One of the objects of the invention consists in making this assembly much more compact than the one shown in FIG. 1, because of the absence of external fasteners, and lighter since the pipe is at least partially realized by overmoulding. The actuator 1 and the pipe 2 of the valve are preferably at least partially surrounded by the overmoulding (consisting of a plastic material) but the actuator 1 has, on its upper part, a cover 19 which contains detecting elements, which cooperate with the rotor 5 of the actuator 1 for determining the position of the rotor 5 with respect to the overmoulded assembly. This cover 19 also has an electrical connections assembly 20 intended to enable the power supply of the actuator 1 and the detecting element.

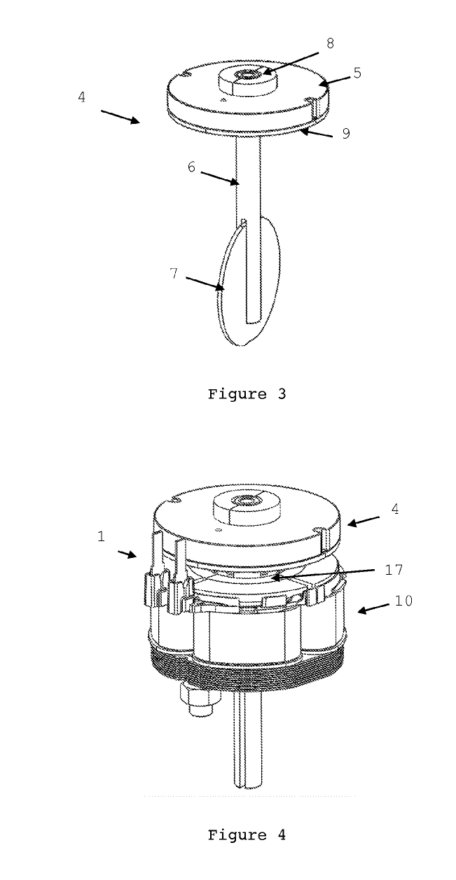

FIG. 3 shows an isolated view of a rotor 4 which can be used in an electromagnetic actuator controlling the valve formed. Such rotor 4 consists of a ferromagnetic yoke 5 carrying motor magnets 9 on a first face, intended to cooperate with the magnetic field of a first stator assembly (not shown) so as to move with respect to the first stator assembly and a sensor magnet 8 on a second face intended to cooperate with a second stator assembly (not shown) so as to provide information on the angular position of the rotor 4 relative to the first stator assembly. The magnetic yoke 5 is secured to a spindle 6 having a split lower part so as to accommodate a valve shutter 7 typically obtained by stamping or straight edge blanking.

FIG. 4 shows the actuator 1 formed by the rotor 4 and the stator assembly 10 carrying coiled ferromagnetic poles. The value and the fluctuation of the electric current in said stator assembly 10 therefore make it possible to move the rotor 4 with respect to the stator assembly 10. Such an exemplary embodiment is given as a preferred example of the function of actuator used but is in no way restrictive.

The actuator 1 preferably comprises a contactless magnetic means for returning the rotor 5 in position. For this purpose, the actuator 1 may have a magnetic track 17 secured to the stator assembly 10 for interacting with the yoke 5 to bring the magnetic rotor back in a predetermined position when the stator assembly 10 is no longer power-supplied.

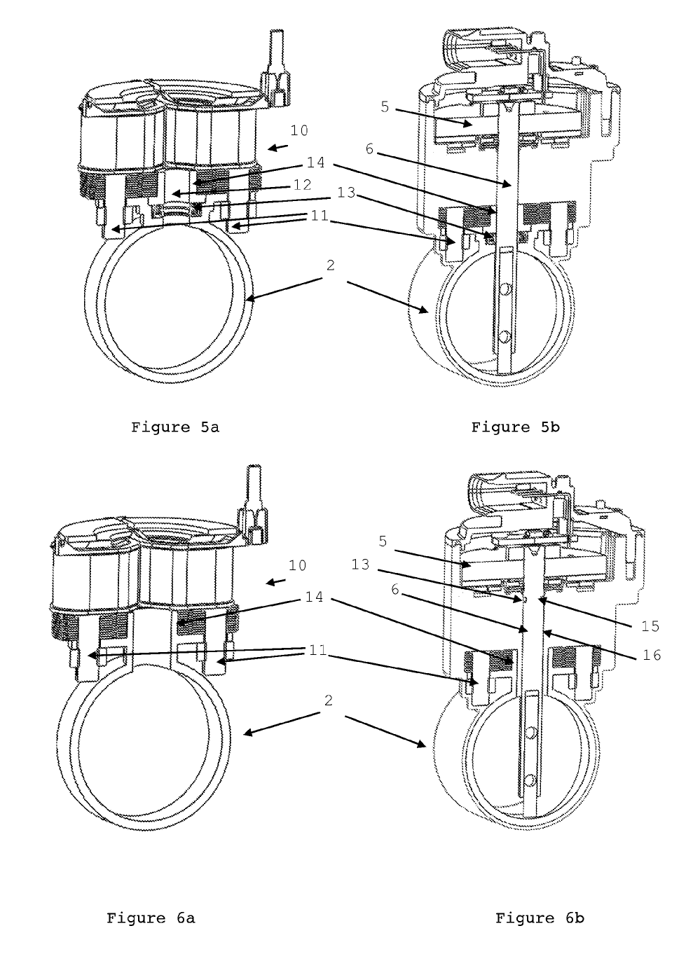

FIGS. 5a and 5b show a first embodiment of the motorized valve according to the invention, wherein the actuator 1 presented above is coupled to a metal, preferably aluminum, base of the pipe 2. Such coupling is provided by using two threaded elements 11 of the stud type, which fasten the stator assembly 10 to the pipe 2.

A sliding ring 12 attached to and fitted tightly on the aluminum pipe 2 is used. Such ring 12 makes it possible to lock a lip seal 13: it protects the seal 13 against damage by the plastic during the overmoulding; it also provides a centering spigot 14 to the stator assembly 10 by a sliding fit. Finally, it provides a good factor OF friction with the spindle 6 of the rotor 5 to ensure low friction and prevent premature wear of the moving assembly.

The overmoulding of the actuator 1 thus also surrounds the pipe 2 to form a unitary, compact and lightweight assembly. In this embodiment, the rotor 5 of the actuator 1 is guided by the ring 12 via the internal cylindrical surface of the centring spigot 14. Static sealing is thus provided by the overmoulding surrounding the actuator and the pipe, thus preventing any fluid from entering the actuator through the stator assembly 10 and dynamic sealing is provided by the single lip seal 13 which prevents any up-motion of the fluid due to the spindle 6 of the actuator 1. In all embodiments, the spindle 6 of the actuator 1 bearing the valve shutter 7 is guided at its upper part—above the valve shutter 7—only and is not guided at the part below the valve shutter 7, which prevents any static indeterminacy.

FIGS. 6a and 6b show a second embodiment of the motorized valve according to the invention, wherein the actuator 1 described above is coupled to a metal base, preferably made of aluminum, of the pipe 2. Such coupling is provided by using two studs 11 fixing the stator assembly 10 to the pipe 2. A one-piece spigot 14 made of aluminum and integral with the pipe 2, enables the centering of the stator assembly 10 on the pipe 2. To prevent any contact between the movable spindle 6—typically made of stainless steel—and the centering spigot 14 of the pipe 2—typically made of aluminum—, the overmoulding makes it possible to make the whole bearing 16 guiding the rotor 4 on almost the whole height of the spindle 6 of plastic material.

Sealing is then directly provided between the spindle 6 and the plastic bearing 16 using a seal 13, here of the O-ring type. A groove 15, the dimensions of which match the section of the seal 13, is provided on the spindle. The O-ring 13 is then inserted. It is in static contact on its outer diameter—plastic bearing—and in dynamic contact on its inner diameter with the stainless steel spindle 6. The dynamic contact is then on the smallest diameter: the sliding speed is lower, the friction on stainless steel is lower and wear is thus reduced. This use of a static seal in a dynamic application is not conventional, but life tests carried out on actuators placed in a climatic oven (thermal cycle −40° C./+150° C.) showed no leakage after 10⁶ cycles with a relative pressure of 2 bars.

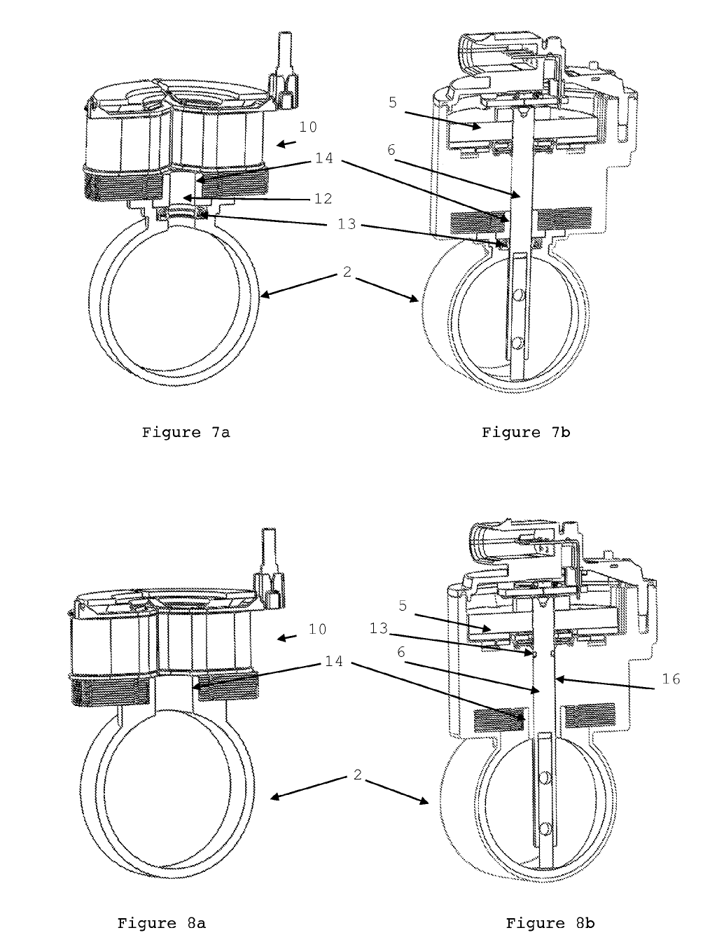

FIGS. 7a and 7b show a third embodiment of the motorized valve according to the invention, wherein a sliding ring 12 attached to and countersunk into the aluminum pipe 2 is used. In addition to the functions shown in the first embodiment (maintenance and protection of the lip seal 13, centering of the stator assembly 10, guiding and sliding of the spindle 6 of the rotor 5), this element makes it possible here to fix the stator assembly 10 on the pipe 2 by a tight fit with the base of the stator assembly 10. This solution is appropriate since it makes it possible to avoid threaded elements (which are expensive, and the mass production of which is difficult to manage) and the plastic overmoulding also provides a good mechanical strength of the assembly (ribs, i.e. specific forms may be provided in the overmoulding to stiffen the assembly if necessary). The sealing is the same as the one described for the first embodiment.

FIGS. 8a and 8b show a fourth embodiment of the motorized valve according to the invention incorporating a combination of the second and third embodiments. The threaded elements are left aside for the benefit of a tight fit centering directly provided between the base of the stator assembly 10 and the aluminum pipe 2 by means of a one-piece centering spigot 14. The guiding of the spindle 6 in the pipe 2 is integrally made of plastic at the time of the overmoulding.

In the embodiments mentioned, the guiding is provided only at the stator assembly (preferred embodiment), but the additional use of a complementary bearing or a roller at the lower end of the pipe may be considered as well. The sealing is the same as in the second embodiment. An O-ring 13 is integrated between the plastic stator assembly 10 and the stainless steel spindle 6 through the utilization of a groove 15 formed on the spindle 6.

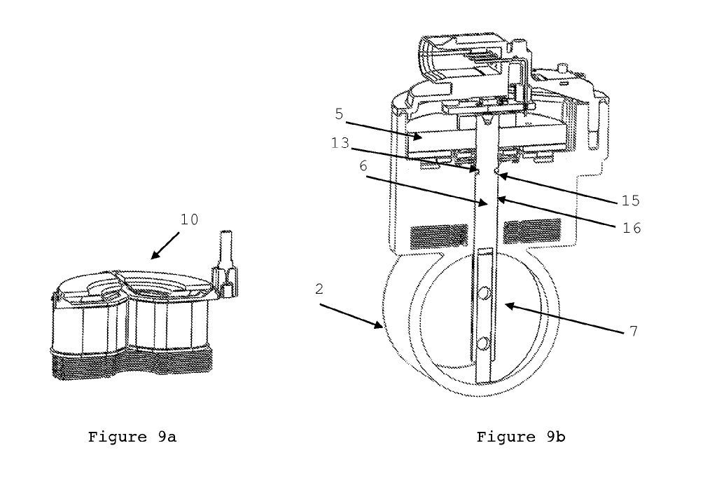

FIGS. 9a and 9b show a fifth embodiment of the motorized valve according to the invention, wherein the pipe 2 is entirely made of overmoulded plastic material. For some specific applications wherein mechanical stress and leakage constraints are less severe, the aluminum part of the pipe 2 can be omitted. The valve can then be totally made of plastic material during the overmoulding operation.

It is no longer necessary to manage the assembly of the aluminum body of the pipe 2 with the stator assembly 10 and the overmoulding operation is greatly simplified. Of course, specific means for stiffening and fixing the assembly to its environment are to be provided on the overmoulding.

No dynamic lip seal can be used in this solution: it would be completely buried in or damaged by plastic. Inserting it after the overmoulding could be considered, but the element would no longer be held, which would entail the non-negligible risk of its falling into the gas pipe. The solution adopted thus consists in using a seal 13 of the O-ring type between the spindle 6 and the plastic bearing 16 formed at the spindle 6 by overmoulding.

1. A motorized valve comprising a closable pipe a valve shutter, a rotary electromagnetic actuator and an overmoulding plastic material, with the actuator being formed of a stator assembly, a rotor secured to a spindle, with the valve shutter being progressively positioned by the actuator using the spindle and able to shut off the pipe, with the overmoulding plastic material surrounding and being secured at least in part to the actuator and forming the pipe at least in part, the static sealing being provided by the overmoulding plastic material common to the actuator and the pipe, with the overmoulding material being gone through by a passage for guiding the spindle which connects the valve shutter and the rotor.

2. A motorized valve according to claim 1, wherein the dynamic sealing of passage is provided through the utilization of a single seal in contact with the spindle.

3. A motorized valve according to claim 1, further comprising a magnetic coupling operably returning the valve shutter in position.

4. A motorized valve according to claim 1, wherein the overmoulding plastic material forms the whole pipe.

5. A motorized valve according to claim 1, wherein the pipe comprises at least partly a base made of metal and a part made of an overmoulding plastic material.

6. A motorized valve according to claim 5, wherein the stator assembly is attached to the metal base of the pipe by threaded elements facilitating the angular indexing of the stator assembly with respect to the spindle of the pipe.

7. A motorized valve according to claim 6, wherein the spindle of the actuator is positioned relative to the metal pipe using a centering spigot attached to the pipe.

8. A motorized valve according to claim 5, wherein the stator assembly is fixed to the metal base of the pipe by a centering spigot attached thereto.

9. A motorized valve according to claim 7, wherein the centering spigot attached to the pipe and a portion of the metal base of the pipe define a housing wherein the single seal is placed.

10. A motorized valve according to claim 5, wherein the spindle of the actuator is positioned with respect to the metal pipe using a centering spigot secured to the metal base of the pipe.

11. A motorized valve according to claim 10, wherein the stator assembly is attached to the metal base of the pipe by a centering spigot secured to the metal base of the pipe.

12. A motorized valve according to claim 4, wherein the single seal is placed on the spindle of the actuator in external static contact with the overmoulding plastic material and in internal sliding contact with the spindle of the actuator.

13. A motorized valve according to claim 12, wherein the single seal is positioned on the spindle of the actuator thanks to a groove provided on the spindle.

14. A motorized valve according to claim 1, further comprising a cover supporting a rotor position detecting element attached to the overmoulding plastic material and fixed by laser welding.

15. A motorized valve according to claim 14, wherein the cover has an electric connection assembly for supplying the actuator and the detecting element.

16. A motorized valve according to claim 1, wherein the guiding of the spindle is executed at the stator assembly only.
